(19) United States
(12) Patent Application Publication
(10) Pub. No.: US 2026/0253071 A1
(43) Pub. Date: Aug. 27, 2026

(54) CONTROL METHOD, DEVICE, AND RECORDING MEDIUM

(71) Applicant: Panasonic Intellectual Property Management Co., Ltd., Osaka (JP)

(72) Inventors: Yasushi TAKAHASHI, Fukuoka (JP); Ayaka Nakasaka, Osaka (JP); Kakuya Yamamoto, Hyogo (JP); Yuji Unagami, Osaka (JP)

(21) Appl. No.: 19/644,708

(22) Filed: Apr. 10, 2026

Related U.S. Application Data
(63) Continuation of application No. PCT/JP2024/037454, filed on Oct. 21, 2024.
(60) Provisional application No. 63/545,995, filed on Oct. 27, 2023.

(51) Int. Cl. G06Q 20/38

(52) U.S. Cl. CPC G06Q 20/389

(57) ABSTRACT

A control method performed by a device includes: obtaining a first computation result from a first smart contract stored on a first blockchain by inputting first data to the first smart contract; generating second data by adding a random value smaller than a norm of the first data to the first data; obtaining a second computation result from the first smart contract by inputting the second data to the first smart contract; and storing the first data and the second data as first inspection data, based on a comparison result of comparing the first computation result and the second computation result.

### CROSS REFERENCE TO RELATED APPLICATIONS

This is a continuation application of PCT International Application No. PCT/JP2024/037454 filed on October 21, 2024, designating the United States of America, which is based on and claims priority of U.S. Provisional Patent Application No. 63/545995 filed on October 27, 2023. The entire disclosures of the above-identified applications, including the specifications, drawings and claims are incorporated herein by reference in their entirety.

### FIELD

The present disclosure relates to a control method, a device, and a recording medium.

### BACKGROUND

Smart contract technology, in which the process from confirming the conditions of a contract to the execution of the contract is performed automatically on a blockchain, has existed for some time. For example, Patent Literature (PTL) 1 discloses a method for automatically executing a procedure for a commercial transaction using smart contract technology.

### Citation List

### Patent Literature

PTL 1: International Publication No. 2019/003414

### SUMMARY

### Technical Problem

The present disclosure provides a control method and the like enabling the identification and storage of data effective for accurately and efficiently comparing the performance of a first smart contract with another smart contract.

### Solution to Problem

A control method according to one aspect of the present disclosure is a control method performed by a device. The control method includes: obtaining a first computation result from a first smart contract stored on a first blockchain by inputting first data to the first smart contract; generating second data by adding a random value smaller than a norm of the first data to the first data; obtaining a second computation result from the first smart contract by inputting the second data to the first smart contract; and storing the first data and the second data as first inspection data, based on a comparison result of comparing the first computation result and the second computation result.

A device according to one aspect of the present disclosure includes a processor and memory connected to the processor. Using the memory, the processor: obtains a first computation result from a first smart contract stored on a first blockchain by inputting first data to the first smart contract; generates second data by adding a random value smaller than a norm of the first data to the first data; obtains a second computation result from the first smart contract by inputting the second data to the first smart contract; and stores the first data and the second data as first inspection data, based on a comparison result of comparing the first computation result and the second computation result.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

### Advantageous Effects

The control method and the like according to the present disclosure enable the identification and storage of data effective for accurately and efficiently comparing the performance of a first smart contract with another smart contract.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the configuration of a system according to an embodiment.

FIG. 2 is a block diagram illustrating an example of the configuration of an information processing device according to the embodiment.

FIG. 3 is a flowchart illustrating a control method executed by an information processing device according to a comparative example.

FIG. 4 is a schematic diagram illustrating a relationship between inspection data and a computation result for a smart contract according to the comparative example.

FIG. 5 is a schematic diagram illustrating a relationship between inspection data and a computation result for two smart contracts according to the comparative example.

FIG. 6 is a flowchart illustrating a control method executed by an information processing device according to Example 1.

FIG. 7 is a schematic diagram illustrating a relationship between inspection data and a computation result for a smart contract according to Example 1.

FIG. 8 is a schematic diagram illustrating a relationship between inspection data and a computation result for two smart contracts according to Example 1.

FIG. 9 is a sequence chart illustrating an example of a method for evaluating the performance of a smart contract.

FIG. 10 is a diagram illustrating an example of a result of comparing two computation results from two smart contracts.

FIG. 11 is a flowchart illustrating a control method executed by an information processing device according to Example 2.

FIG. 12 is a schematic diagram illustrating a relationship between inspection data and a computation result for a smart contract according to Example 2.

FIG. 13 is a schematic diagram illustrating a relationship between inspection data and a computation result for two smart contracts according to Example 2.

FIG. 14 is an explanatory diagram illustrating the data structure of a blockchain.

FIG. 15 is an explanatory diagram illustrating the data structure of transaction data.

FIG. 16 is an explanatory diagram illustrating transaction data related to the execution of a smart contract.

FIG. 17 is an explanatory diagram illustrating processing related to the execution of a smart contract.

### DESCRIPTION OF EMBODIMENT

### Underlying Knowledge Forming Basis of Present Disclosure

A blockchain may be used alone within a system, but a plurality of blockchains are sometimes configured to work together. For example, it is conceivable for a plurality of blockchains to be managed by a plurality of companies (i.e., a plurality of administrators). It is also conceivable for the plurality of blockchains to be managed using different blockchain platforms (e.g., Ethereum, Fabric, and the like). A system that manages power data can be considered as one use case for a system that uses a plurality of blockchains.

Such a system includes a plurality of power meter devices, a first blockchain system, and a second blockchain system, for example. The plurality of power meter devices include a plurality of first power meter devices belonging to a first group and a plurality of second power meter devices belonging to a second group. Each of the plurality of power meter devices is provided for a corresponding household or corresponding facility, and measures the amount of power consumed by the household or the facility in which the power meter device is provided, or, if the household or facility has a generator, measures the amount of power generated by the generator in the household or the facility where the power meter device is provided. The plurality of power meter devices can be realized by smart meters, power conditioners, or the like, for example. The plurality of power meter devices are communicably connected to a network and send measurement results to the corresponding blockchain system. The measurement results are sent to the blockchain system after being stored in transaction data, for example.

The first blockchain system collects measurement results from the plurality of first power meter devices belonging to the first group. The first blockchain system receives the transaction data including the measurement results, executes a first smart contract stored in the first blockchain system based on the received transaction data, and outputs a computation result. The first smart contract verifies whether the measurement results contain an anomaly, for example, and a computation result indicating that the measurement result is normal or a computation result indicating that the measurement result is anomalous is output. If the measurement result satisfies a predetermined condition, the measurement result may be determined to be anomalous, and if not, the measurement result may be determined to be normal. The predetermined condition is, for example, (1) that the amount of generated power or amount of consumed power in the measurement result is a negative value, (2) that the amount of generated power included in the measurement result is greater than a maximum value that can be generated during a predetermined period of time calculated based on the power generation capacity of the generator, (3) that the amount of consumed power included in the measurement result is greater than a predetermined threshold, or the like.

The second blockchain system collects measurement results from the plurality of second power meter devices belonging to the second group. The second blockchain system receives the transaction data including the measurement results, executes a second smart contract stored in the second blockchain system based on the received transaction data, and outputs a computation result. The second smart contract verifies whether the measurement results contain an anomaly, for example, and a computation result indicating that the measurement result is normal or a computation result indicating that the measurement result is anomalous is output. It is assumed that the second smart contract executes a computation similar to that of the first smart contract. Note that the second blockchain system is a blockchain system different from the first blockchain system, and is managed by a second administrator different from a first administrator of the first blockchain system.

Incidentally, the measurement results processed by the first blockchain system and the measurement results processed by the second blockchain system may be jointly managed by a third administrator. If a plurality of measurement results managed by two blockchain systems are jointly managed in this manner, it is necessary for the performance of the first smart contract of the first blockchain system and the performance of the second smart contract of the second blockchain system to be equivalent in order to omit processing through which the third administrator further determines whether the measurement results are normal.

However, because each administrator wishes to keep the data managed by the corresponding blockchain system secret, the data managed by the first blockchain system is not disclosed to anyone other than the first administrator, and the data managed by the second blockchain system is not disclosed to anyone other than the second administrator. The first administrator therefore does not know how the measurement results from the power meter devices are determined by the second smart contract of the second blockchain system managed by the second administrator. Similarly, the second administrator does not know how the measurement results from the power meter devices are determined by the first smart contract of the first blockchain system managed by the first administrator.

Accordingly, it is necessary for each administrator to verify whether the performance of the smart contract of the blockchain system of their own company is equivalent to the performance of the smart contract of the blockchain system of another company based on computation results output when the measurement results are input to the smart contract of another blockchain system managed by another administrator. However, there is a problem in that accurate verification requires that a large amount of data be input to the smart contract. Because a large amount of input data is required, there is a further problem in that a large amount of communication is required to send the large amount of input data to the blockchain system of the other company. There is yet another problem in that smart contract processing for the large amount of input data is necessary, which increases the processing load. In other words, there is a problem in that an increased amount of communication and a greater processing load are required to compare the performance of the smart contract of one company with the performance of the smart contract of another company.

In view of these problems, the inventors of the present disclosure arrived at a control method and the like enabling the identification and storage of data effective for accurately and efficiently comparing the performance of a first smart contract with another smart contract.

A control method according to a first aspect is a control method performed by a device. The control method includes: obtaining a first computation result from a first smart contract stored on a first blockchain by inputting first data to the first smart contract; generating second data by adding a random value smaller than a norm of the first data to the first data; obtaining a second computation result from the first smart contract by inputting the second data to the first smart contract; and storing the first data and the second data as first inspection data, based on a comparison result of comparing the first computation result and the second computation result.

Through this, two items of first data and second data different from each other by less than the norm of the first data, e.g., first data and second data for which the computation results from the first smart contract are different, can be identified. In other words, two items of data near a boundary separating the computation results from the first smart contract can be identified, and those two items of data can be stored as inspection data. Accordingly, data effective for accurately comparing the performance of the first smart contract with another smart contract can be identified and stored as the inspection data.

A control method according to a second aspect is the control method according to the first aspect, wherein the first data and the second data are stored as the first inspection data when the first computation result and the second computation result are different, and the storing of the first data and the second data is skipped when the first computation result and the second computation result are identical.

Through this, two items of first data and second data different from each other by less than the norm of the first data, and for which the computation results from the first smart contract are different, can be identified. In other words, two items of data near a boundary separating the computation results from the first smart contract can be identified, and those two items of data can be stored as inspection data. Accordingly, data effective for accurately comparing the performance of the first smart contract with another smart contract can be identified and stored as the inspection data.

A control method according to a third aspect is the control method according to the first aspect or the second aspect, further including: generating third data by adding a random value smaller than a norm of the second data to the second data; obtaining a third computation result from the first smart contract by inputting the third data to the first smart contract; and storing the second data and the third data as the first inspection data based on a comparison result of comparing the second computation result and the third computation result.

Accordingly, based on the second data already stored as inspection data, third data which is different from the second data by less than the norm of the second data, and for which the computation result from the first smart contract is different from that for the second data, can be identified. Accordingly, data effective for accurately comparing the performance of the first smart contract with another smart contract can be further identified and stored as the inspection data.

A control method according to a fourth aspect is the control method according to the third aspect, further including: skipping the storing of the second data and the third data when the second computation result and the third computation result are identical; generating fourth data different from the third data by adding a random value smaller than the norm of the second data to the second data; obtaining a fourth computation result from the first smart contract by inputting the fourth data to the first smart contract; and storing the second data and the fourth data as the first inspection data when the second computation result and the fourth computation result are different.

Accordingly, based on the second data already stored as inspection data without storing the third data for which the computation result is identical to that of the second data, data which is different from the second data by less than the norm of the second data, and for which the computation result from the first smart contract is different from that for the second data, is identified. In other words, because data satisfying the stated condition is searched for with respect to the second data, one item of data can be identified with ease. Accordingly, data effective for accurately comparing the performance of the first smart contract with another smart contract can be further identified and stored as the inspection data.

A control method according to a fifth aspect is the control method according to any one of the first aspect to the fourth aspect, further including: obtaining, from the first smart contract, N fifth computation results corresponding to N items of the first inspection data stored, N being a natural number of 2 or more; obtaining N sixth computation results from a second smart contract by inputting each of the N items of the first inspection data to the second smart contract, the N sixth computation results corresponding to the N items of the first inspection data; determining whether a performance of the second smart contract is equivalent to a performance of the first smart contract based on a comparison result of comparing corresponding ones of the N fifth computation results and the N sixth computation results; and outputting a determination result of the determining.

Because N items of the first inspection data are used to determine whether the performance of the first smart contract and the performance of the second smart contract are equivalent, a determination result with good accuracy can be obtained.

A control method according to a sixth aspect is the control method according to the fifth aspect, wherein N comparison results are generated by comparing the N fifth computation results and the N sixth computation results for each of corresponding ones of the first inspection data, and whether the performance of the second smart contract is equivalent to the performance of the first smart contract is determined based on a total number of the N comparison results in which corresponding ones of the fifth computation results and the sixth computation results are identical.

Accordingly, it is easy to determine whether the performance of the first smart contract and the performance of the second smart contract are equivalent.

A control method according to a seventh aspect is the control method according to the sixth aspect, wherein when the total number of the N comparison results in which corresponding ones of the fifth computation results and the sixth computation results are identical is at least M, the performance of the second smart contract is determined to be equivalent to the performance of the first smart contract, and when the total number is less than M, the performance of the second smart contract is determined to be different from the performance of the first smart contract, M being a natural number smaller than N, and M is a number that is a predetermined percentage of N.

Accordingly, it is easy to determine whether the performance of the first smart contract and the performance of the second smart contract are equivalent.

A control method according to an eighth aspect is the control method according to any one of the first aspect to the fourth aspect, further including: generating L items of second inspection data by repeating, L times, a process of adding, to one item of the first inspection data among N items of the first inspection data stored, a random value smaller than a norm of the first inspection data, the L items of the second inspection data being different from the N items of the first inspection data, N being a natural number of 2 or more, and L being a natural number of 2 or more; obtaining, from the first smart contract, (N + L) seventh computation results corresponding to the N items of the first inspection data and the L items of the second inspection data; obtaining (N + L) eighth computation results from a second smart contract by inputting the N items of the first inspection data and the L items of the second inspection data to the second smart contract, the (N + L) eighth computation results corresponding to respective ones of the N items of the first inspection data and the L items of the second inspection data; determining whether a performance of the second smart contract is equivalent to a performance of the first smart contract based on a comparison result of comparing the (N + L) seventh computation results and the (N + L) eighth computation results; and outputting a determination result of the determining.

Through this, the performance of the first smart contract and the performance of the second smart contract are determined to be equivalent using the first inspection data and the second inspection data having a lower determination result accuracy than the first inspection data, and it is therefore possible to determine whether the performance of the first smart contract and the performance of the second smart contract are equivalent with greater accuracy.

A control method according to a ninth aspect is the control method according to the eighth aspect, wherein (N + L) comparison results are generated by comparing the (N + L) seventh computation results and the (N + L) eighth computation results for each of corresponding ones of the first inspection data or each of corresponding ones of the second inspection data, and the determining is performed such that of the (N + L) comparison results, N comparison results for corresponding ones of the first inspection data have a greater effect than L comparison results for corresponding ones of the second inspection data.

Through this, it is determined whether the performance of the first smart contract and the performance of the second smart contract are equivalent such that the comparison result for the first inspection data has a greater effect than the comparison result for the second inspection data, and it is therefore possible to determine whether the performance of the first smart contract and the performance of the second smart contract are equivalent with greater accuracy.

A device according to a tenth aspect includes a processor and memory connected to the processor. Using the memory, the processor: obtains a first computation result from a first smart contract stored on a first blockchain by inputting first data to the first smart contract; generates second data by adding a random value smaller than a norm of the first data to the first data; obtains a second computation result from the first smart contract by inputting the second data to the first smart contract; and stores the first data and the second data as first inspection data, based on a comparison result of comparing the first computation result and the second computation result.

Through this, two items of first data and second data different from each other by less than the norm of the first data, e.g., first data and second data for which the computation results from the first smart contract are different, can be identified. In other words, two items of data near a boundary separating the computation results from the first smart contract can be identified, and those two items of data can be stored as inspection data. Accordingly, data effective for accurately comparing the performance of the first smart contract with another smart contract can be identified and stored as the inspection data.

A recording medium according to an eleventh aspect is a non-transitory computer-readable recording medium having recorded thereon a program for causing a computer to execute a control method performed by a device. The control method includes: obtaining a first computation result from a first smart contract stored on a first blockchain by inputting first data to the first smart contract; generating second data by adding a random value smaller than a norm of the first data to the first data; obtaining a second computation result from the first smart contract by inputting the second data to the first smart contract; and storing the first data and the second data as first inspection data, based on a comparison result of comparing the first computation result and the second computation result.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

An embodiment will be described hereinafter with reference to the drawings. Note that the following embodiment describes specific examples of the present disclosure. In other words, the numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims indicating the broadest interpretation are not absolutely necessary for solving the problem of the present disclosure, and will instead be described as constituent elements constituting more preferred forms.

### Embodiment

The present embodiment will describe a control method and the like that make it possible to determine whether a smart contract stored in a company’s own blockchain system has performance equivalent to that of a smart contract stored in another company’s confidential blockchain system.

### System Configuration

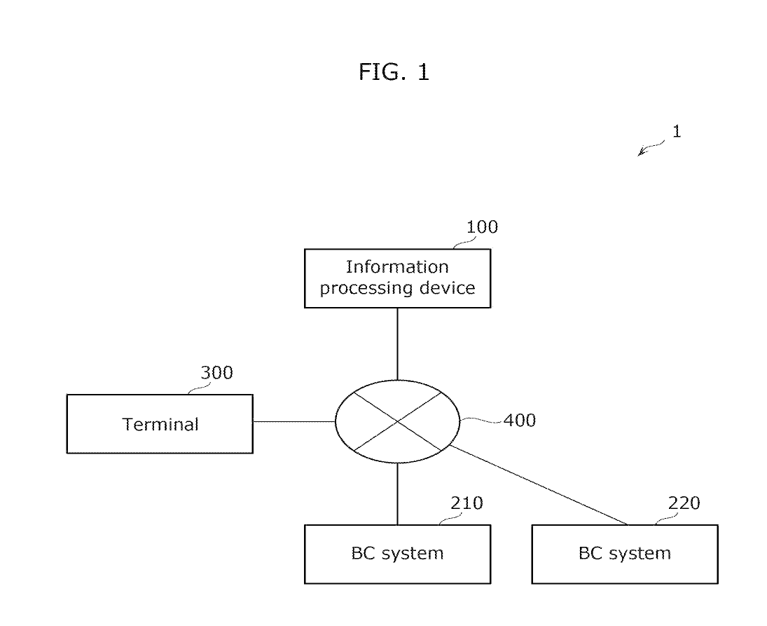

FIG. 1 is a block diagram illustrating the configuration of a system according to the embodiment.

As illustrated in FIG. 1, system 1 includes information processing device 100, blockchain system 210, blockchain system 220, and terminal 300. Note that “blockchain system” is denoted as “BC” in FIG. 1.

Information processing device 100, blockchain system 210, blockchain system 220, and terminal 300 may all be connected to each other over network 400, may all be communicatively connected directly to each other, or some may be connected over network 400 while others are communicatively connected directly to each other. Network 400 is, for example, the Internet, a cellular telephone carrier network, or the like, but may be constituted by any communication line or network.

Information processing device 100 is a device that receives operations made by a first administrator who manages blockchain system 210. Information processing device 100 is an example of the device that determines whether a smart contract stored in a company’s own blockchain system 210 has performance equivalent to that of the smart contract stored on another company’s confidential blockchain. Note that information processing device 100 may be one of a plurality of nodes constituting blockchain system 210.

Blockchain system 210 is managed by the first administrator. For example, blockchain system 210 stores output data output by terminal 300 in the possession of a user provided with a first service, the first service being provided by the first administrator. Blockchain system 210 includes a plurality of nodes. Each node is a server that manages the output data using a distributed ledger. The distributed ledger is implemented by a first blockchain, for example. Each node stores the distributed ledger in storage. When transaction data is received, each node executes processing by a first smart contract stored on the first blockchain, based on the received transaction data.

Each node is capable of sending and receiving communication data to and from other nodes. Each node sends the received transaction data to other nodes to cause the transaction data to be stored in the distributed ledgers provided in the other nodes as well. When storing the transaction data, the transaction data may be stored after first using a consensus algorithm to form a consensus. The transaction data stored in the distributed ledger is managed using properties such as hash values to prevent tampering.

For example, when the distributed ledger is a blockchain, each node generates a block containing the new transaction data and stores the block in the distributed ledger after using a consensus algorithm to form a consensus with each node and the like for the generated block. Note that the format of the distributed ledger is not limited to the foregoing, and other distributed ledger formats (e.g., IOTA, Hashgraph, or the like) can also be used. A plurality of the nodes may operate independently of each other.

Blockchain system 220 is managed by a second administrator. For example, blockchain system 220 stores output data output by a terminal in the possession of a different user provided with a second service, the second service being provided by the second administrator. Like blockchain system 210, blockchain system 220 includes a plurality of nodes. The functions of the plurality of nodes are the same as the functions of the plurality of nodes provided in blockchain system 210. The distributed ledger managed by blockchain system 220 is implemented by a second blockchain, for example. When transaction data is received, each node executes processing by a first smart contract stored on the second blockchain, based on the received transaction data. Note that the second service is the same type of service as the first service.

Here, the first service and the second service are a service for providing power, for example. The first administrator and the second administrator are power companies, for example.

Terminal 300 is a terminal in the possession of the user provided with the first service, as mentioned above. Specifically, terminal 300 is a terminal that outputs data pertaining to a usage amount of the first service by the user. Terminal 300 is a terminal that measures an amount of power provided to the user (i.e., a consumed power amount), for example. Terminal 300 is also a terminal that measures an amount of power provided by a generator in the possession of the user (i.e., a generated power amount). Terminal 300 is implemented by a power conditioner, a smart meter, or the like, for example.

Although illustrated as including only one terminal 300 in FIG. 1, system 1 may include a plurality of terminals 300. The plurality of terminals 300 correspond to a plurality of users provided with the first service, for example. As such, each of the plurality of terminals 300 outputs data pertaining to the usage amount used by the user corresponding to that terminal 300. The output data may therefore include a terminal ID identifying that terminal 300, or a user ID identifying the user corresponding to that terminal 300.

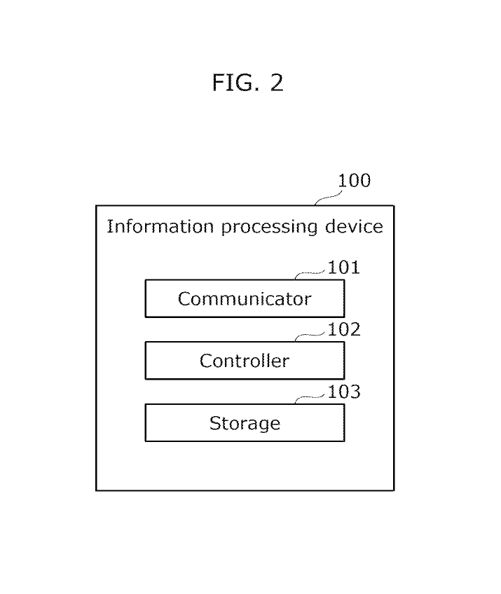

FIG. 2 is a block diagram illustrating an example of the configuration of the information processing device according to the embodiment.

As illustrated in FIG. 2, information processing device 100 includes communicator 101, controller 102, and storage 103. Communicator 101, controller 102, and storage 103 can be realized by a processor (e.g., a Central Processing Unit (CPU)) (not shown) included in information processing device 100 executing predetermined programs using memory (not shown). Information processing device 100 is an example of a device.

Communicator 101 communicates with blockchain system 210 and terminal 300 over network 400. Communicator 101 receives information from terminal 300 and blockchain system 210. Communicator 101 sends information to terminal 300 and blockchain system 210.

Controller 102 executes various types of processing based on the received information. Specifically, controller 102 stores received information in storage 103. Controller 102 also generates inspection data for efficiently evaluating the performance of a smart contract based on the output data received from terminal 300. Furthermore, using the inspection data, controller 102 determines whether the performance of a first smart contract stored in blockchain system 210 and the performance of a second smart contract stored in blockchain system 220 are equivalent.

Storage 103 stores data received by communicator 101. Specifically, storage 103 may store the output data received from terminal 300. Storage 103 may also store the inspection data generated by controller 102.

### Operations in Comparative Example

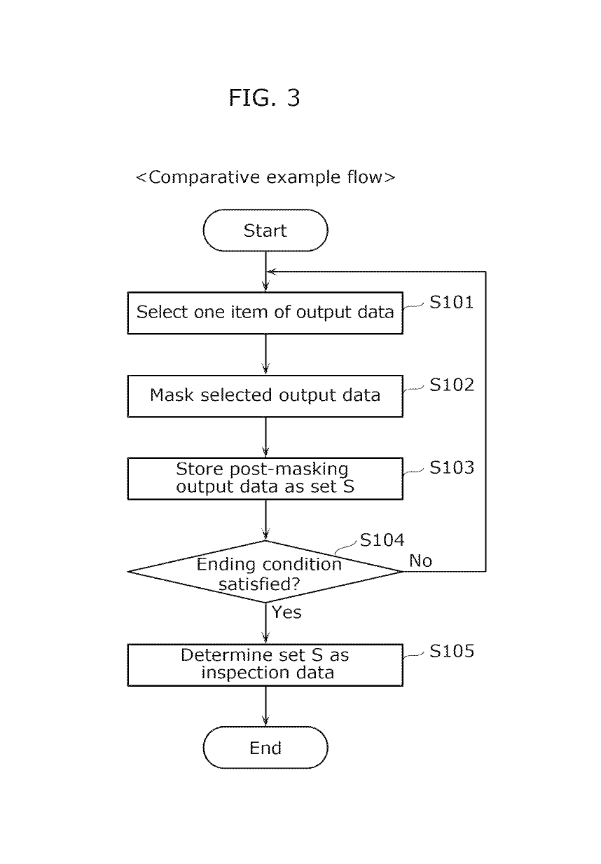

Operations by an information processing device according to a comparative example will be described next. FIG. 3 is a flowchart illustrating a control method executed by the information processing device according to the comparative example.

The operations described here are operations performed in a generation method in which based on a plurality of items of output data received from terminals, the information processing device generates inspection data for input to a smart contract in order to evaluate the performance of the smart contract.

Here, the information processing device has obtained the plurality of items of output data from the terminals, and has stored the plurality of items of output data in storage included in the information processing device.

The information processing device selects one item of output data among the plurality of items of output data stored in the storage (S101).

The information processing device masks the one item of output data selected (S102). Specifically, the information processing device adds, to the one item of output data, a random value smaller than a norm of the output data.

The information processing device stores the post-masking output data as set S (S103).

The information processing device determines whether an ending condition is satisfied (S104). If the ending condition is determined to be satisfied (Yes in S104), the information processing device executes step S105, whereas if the ending condition is determined not to be satisfied (No in S104), the information processing device executes step S101 on an unselected item of output data among the plurality of items of output data.

The ending condition is, for example, that a total number of post-masking output data stored as set S has reached a predetermined number. The predetermined number is a number of 2 or more, and may be, for example, 100, 1,000, 10,000, or the like. In other words, the information processing device selects a predetermined number of post-masking items of output data by repeating steps S101 to S104.

Note that the ending condition is not limited to the foregoing, and may be that a number of repetitions has reached a predetermined number. The number of repetitions is the number of times a process is repeated, and may be the number of times step S103 is executed, for example. The ending condition may also be that a gas bill (fee) required to execute processing by the smart contract has reached a predetermined value.

The information processing device determines each of the predetermined number of post-masking items of output data stored as set S as inspection data (S105).

In this manner, the information processing device generates a predetermined number of items of inspection data to be input to the smart contract in order to evaluate the performance of the smart contract.

The evaluation of the performance of the first smart contract and the second smart contract according to the comparative example will be described here.

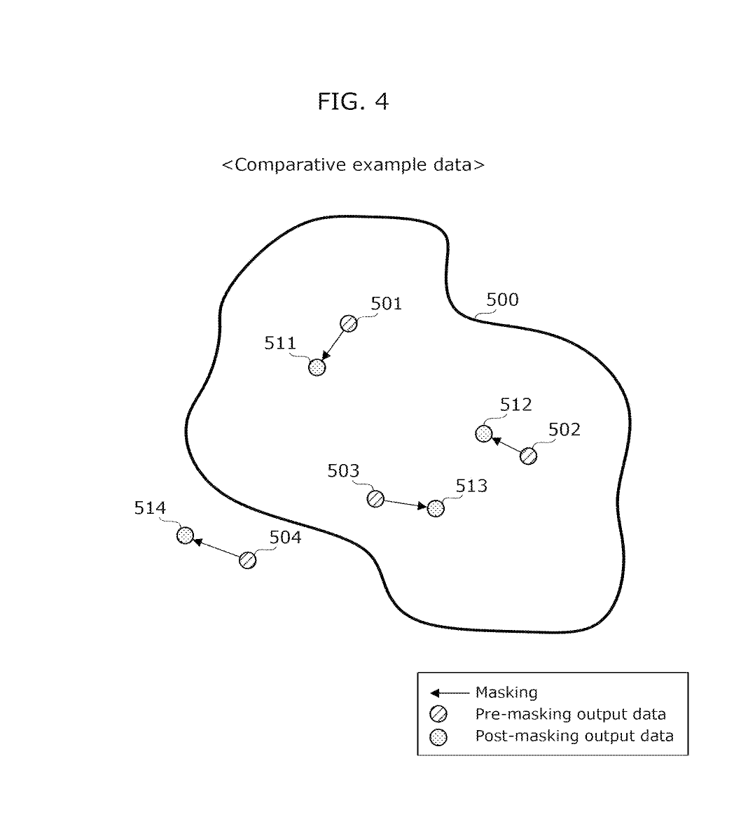

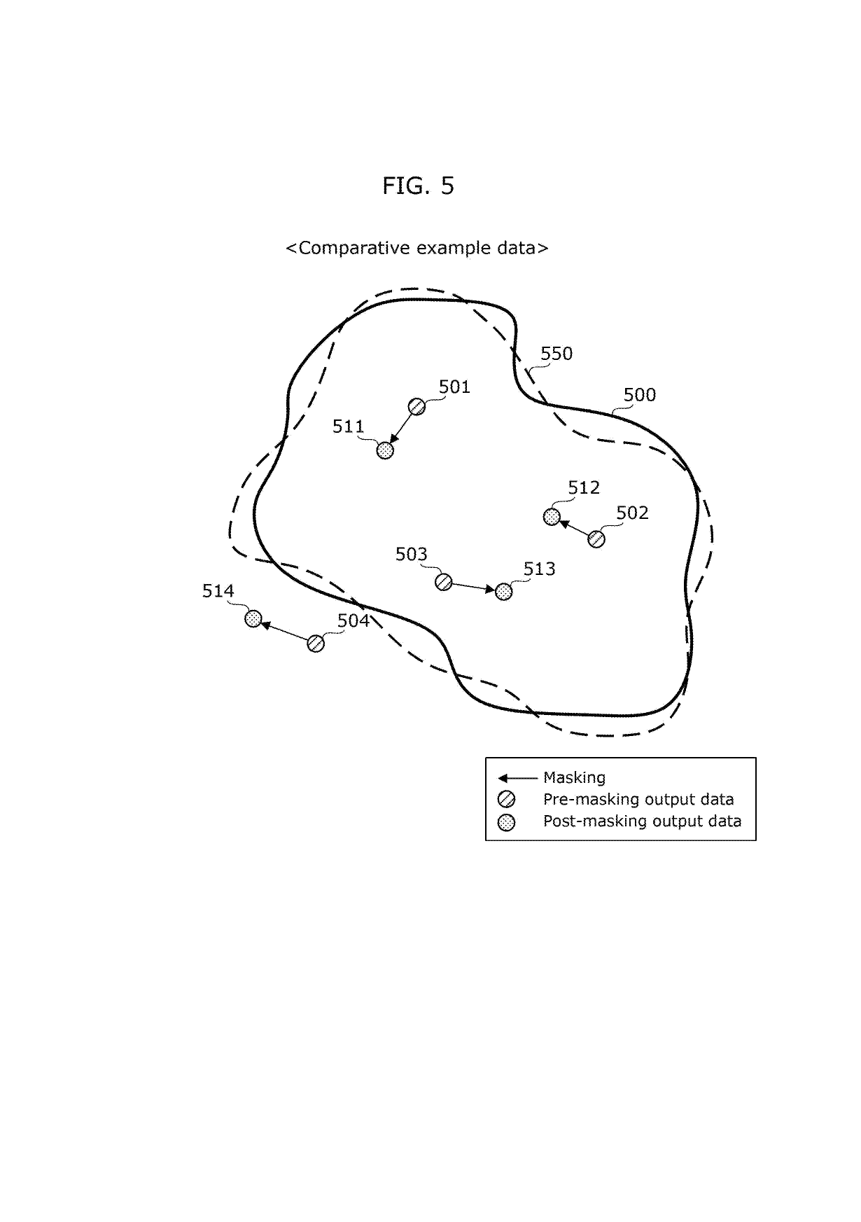

FIG. 4 is a schematic diagram illustrating a relationship between inspection data and a computation result for a smart contract according to the comparative example. FIG. 5 is a schematic diagram illustrating a relationship between inspection data and a computation result for two smart contracts according to the comparative example.

For example, as illustrated in FIG. 4, by masking each of a plurality of items of output data 501 to 504, the information processing device generates a plurality of post-masking items of output data 511 to 514 as the predetermined number of items of inspection data. In FIG. 4, a boundary of determination by the first smart contract is expressed as an annular line 500. For example, output data or post-masking output data in the region within line 500 indicates data determined to be normal by the first smart contract. Output data or post-masking output data in the region outside line 500 indicates data determined to be anomalous by the first smart contract.

Here, the plurality of post-masking items of output data 511 to 514 are data generated as the predetermined number of items of inspection data. FIG. 4 illustrates a state in which based on the first smart contract, post-masking output data 511 to 513 have been determined to be normal, whereas post-masking output data 514 has been determined to be anomalous.

In FIG. 5, a boundary of determination by the second smart contract different from the first smart contract is expressed as an annular line 550, in addition to the content of FIG. 4. For example, output data or post-masking output data in the region within line 550 indicates data determined to be normal by the second smart contract. Output data or post-masking output data in the region outside line 550 indicates data determined to be anomalous by the second smart contract.

FIG. 5 illustrates a state in which based on the second smart contract, post-masking output data 511 to 513 have been determined to be normal, whereas post-masking output data 514 has been determined to be anomalous. In other words, a computation result based on the first smart contract and a computation result based on the second smart contract are identical. However, line 500 corresponding to the first smart contract and line 550 corresponding to the second smart contract are different, and thus the performance of the first smart contract and the performance of the second smart contract are actually expected to be different. In other words, it is difficult to evaluate the performance of the first smart contract and the performance of the second smart contract as being different, even when comparing the computation results.

### Operations in Example 1

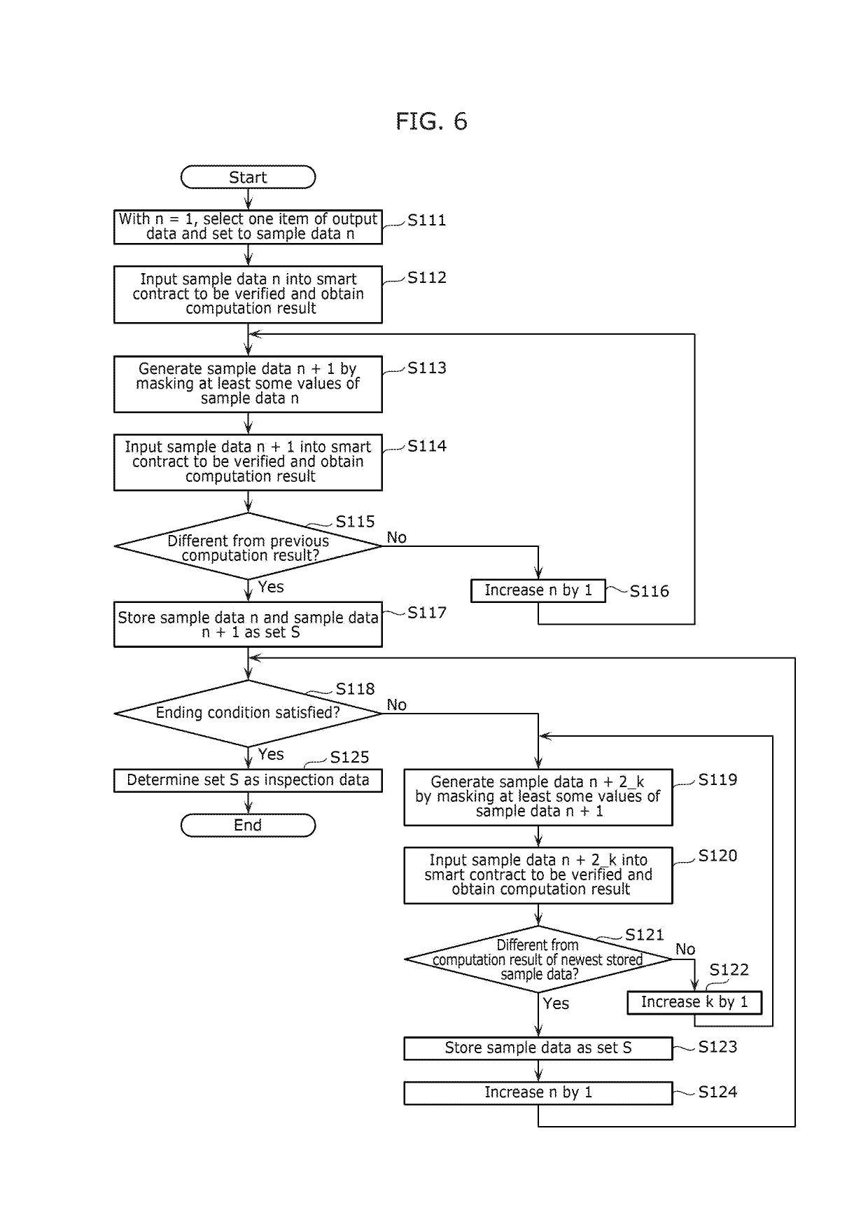

Operations by information processing device 100 according to Example 1 will be described next. FIG. 6 is a flowchart illustrating a control method executed by the information processing device according to Example 1.

Information processing device 100 selects one item of output data, and sets the one item of output data selected as sample data n (n = 1) (S111). Sample data n (n = 1) is an example of first data.

Information processing device 100 obtains first computation result R11 from the smart contract to be verified by inputting sample data n to the smart contract to be verified the (first smart contract) (S112).

Information processing device 100 generates sample data n + 1 by masking at least some of the values of sample data n (S113). Specifically, information processing device 100 generates sample data n + 1 by adding a random value smaller than a norm of sample data n to sample data n. Sample data n + 1 is an example of second data.

Information processing device 100 obtains second computation result R12 from the smart contract to be verified by inputting sample data n + 1 to the smart contract to be verified (S114).

Information processing device 100 determines whether the computation result is different from the immediately-previous computation result (S115). Specifically, information processing device 100 determines whether second computation result R12 obtained in step S114 is different from the computation result from the first smart contract from immediately before second computation result R12. In other words, information processing device 100 determines whether the two newest computation results among the plurality of computation results from the first smart contract are different.

If the computation result is determined to be different from the immediately-previous computation result (Yes in S115), information processing device 100 executes step S117. If the computation result is determined to be identical to the immediately-previous computation result (No in S115), information processing device 100 increases the number set for n by one (S116) and executes step S113. In this manner, information processing device 100 identifies two items of sample data having different computation results by executing steps S113 to S116.

Information processing device 100 stores sample data n and sample data n + 1 as set S (S117). Here, sample data n and sample data n + 1 stored as set S are two items of sample data determined to have different computation results from the first smart contract in step S115.

Information processing device 100 determines whether an ending condition is satisfied (S118). If the ending condition is determined to be satisfied (Yes in S118), information processing device 100 executes step S125, whereas if the ending condition is determined not to be satisfied (No in S118), information processing device 100 executes step S119. Note that the ending condition is the same as the ending condition described in the comparative example.

Information processing device 100 generates sample data n + 2_k (where k = 1) by masking at least some of the values of sample data n + 1 (S119). Specifically, information processing device 100 generates sample data n + 2_k (k = 1) by adding a random value smaller than a norm of sample data n + 1 to sample data n + 1 (S119). Sample data n + 2_k is managed as sample data n + 2. Sample data n + 2_k (k = 1) is an example of third data.

Information processing device 100 obtains third computation result R13 from the smart contract to be verified by inputting sample data n + 2 to the smart contract to be verified (S120).

Information processing device 100 determines whether the computation result is different from the computation result for the newest sample data stored as set S (S121). Specifically, information processing device 100 determines whether third computation result R13 obtained in step S120 is different from the computation result from the first smart contract for the newest sample data stored. In other words, whether the two newest computation results among the plurality of computation results from the first smart contract are different is determined.

If the computation result for the newest sample data stored as set S is determined to be different (Yes in S121), information processing device 100 executes step S123. If the computation result for the newest sample data stored as set S is determined to be identical (No in S121), information processing device 100 increases the number set for k by 1 (S122) and executes step S119. In this manner, information processing device 100 identifies sample data n + 2 having a different computation result from sample data n + 1 by executing steps S119 to S122.

For example, when executing S119 again, information processing device 100 generates sample data n + 2_2 different from sample data n + 2_1 by adding a random value smaller than the norm of sample data n + 1 to sample data n + 1. Sample data n + 2_2 is an example of fourth data. Then, when executing S120 again, information processing device 100 obtains fourth computation result R14 from the smart contract to be verified by inputting sample data n + 2_2 to the smart contract to be verified.

Information processing device 100 stores the sample data determined to have a different computation result from the computation result of the newest stored sample data as set S (S123).

Information processing device 100 determines each of the plurality of items of sample data stored as set S as the inspection data (S125). As a result, each of sample data n and sample data n + 1 determined to have different computation results from each other are stored as the inspection data. In addition, the sample data determined to have a different computation result from the newest stored sample data is stored as the inspection data.

The evaluation of the performance of the first smart contract and the second smart contract according to Example 1 will be described here.

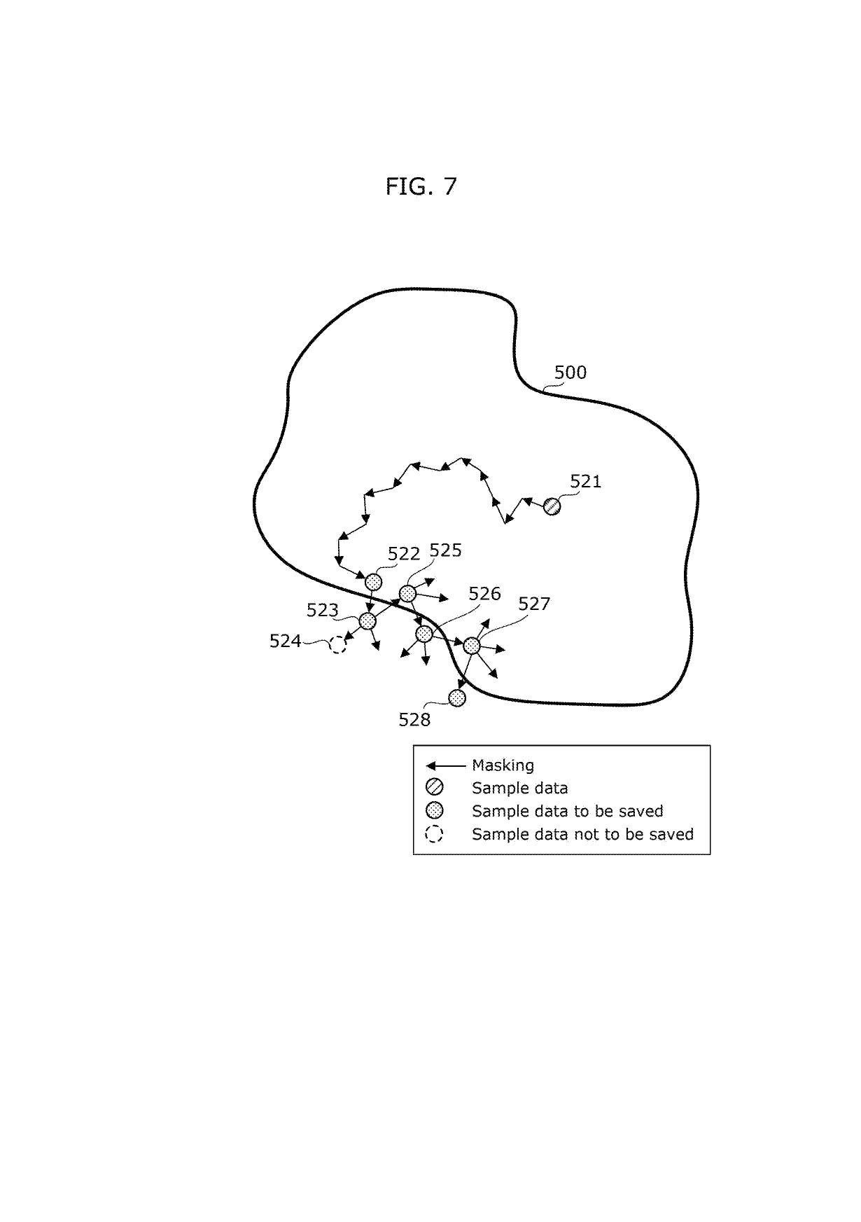

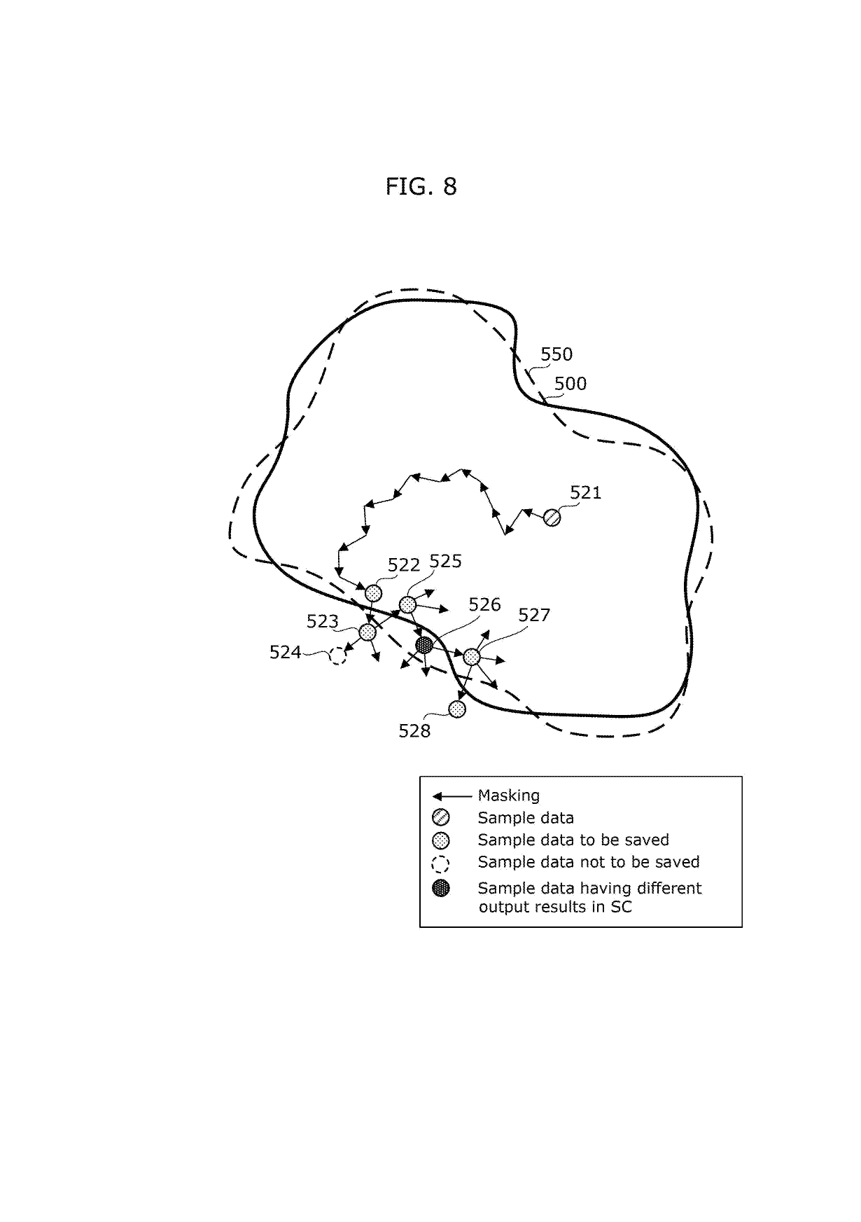

FIG. 7 is a schematic diagram illustrating a relationship between inspection data and a computation result for a smart contract according to Example 1. FIG. 8 is a schematic diagram illustrating a relationship between inspection data and a computation result for two smart contracts according to Example 1.

For example, as illustrated in FIG. 7, information processing device 100 takes one item of output data as sample data 521 (sample data n (n = 1)), and by repeating steps S111 to S116, repeats masking based on sample data 521 to identify two items of sample data 522 and 523 having different computation results in the smart contract between before and after the masking. Like FIG. 4, in FIG. 7, a boundary of determination by the first smart contract is expressed as an annular line 500.

Information processing device 100 then repeats the processing of steps S119 to S124 based on sample data 523 to identify the sample data to be stored as inspection data. Information processing device 100 generates sample data 524 by masking sample data 523. Because sample data 523 and 524 are both in the region outside line 500, the computation result from the first smart contract for sample data 523 and the computation result from the first smart contract for sample data 524 are identical. Accordingly, information processing device 100 generates sample data 525 different from sample data 524 by masking sample data 523 without storing sample data 524 as inspection data. Because sample data 523 is in the region outside line 500 and sample data 525 is in the region inside line 500, the computation result from the first smart contract for sample data 523 and the computation result from the first smart contract for sample data 525 are different. Accordingly, information processing device 100 stores sample data 525 as inspection data.

By repeating the same processing, information processing device 100 can identify sample data 526 having a different computation result from sample data 525 as inspection data based on sample data 525, identify sample data 527 having a different computation result from sample data 526 as inspection data based on sample data 526, and identify sample data 528 having a different computation result from sample data 527 as inspection data based on sample data 527. As a result, sample data 522, 525, and 527 determined to be normal and sample data 523, 526, and 528 determined to be anomalous are stored as the inspection data, respectively. The stored inspection data may be displayed on a display (not shown).

In FIG. 8, a boundary of determination by the second smart contract different from the first smart contract is expressed as an annular line 550, in addition to the content of FIG. 7. Line 550 is the same as in FIG. 5.

In FIG. 8, among sample data 522, 523, and 525 to 528 stored as the inspection data, sample data 522 and 525 to 527 are determined to be normal based on the second smart contract, and sample data 523 and 528 are determined to be anomalous based on the second smart contract. In other words, the computation result for sample data 526 differs between the first smart contract and the second smart contract. This is partly due to the fact that sample data near the boundary for the determination by the smart contract can be determined to be inspection data as a result of determining, as the inspection data, sample data for which the smart contract produces a different computation result before and after the masking, as in Example 1. In other words, this is because the inspection data is a set of sample data near the boundary, and it is therefore more likely that sample data 526 present in a region where the computation result differs between the two smart contracts will be determined as the inspection data. Accordingly, by determining sample data for which the smart contract produces a different computation result before and after the masking as the inspection data, as in Example 1, inspection data for accurately determining whether there is a difference in the performances of the two smart contracts can be obtained.

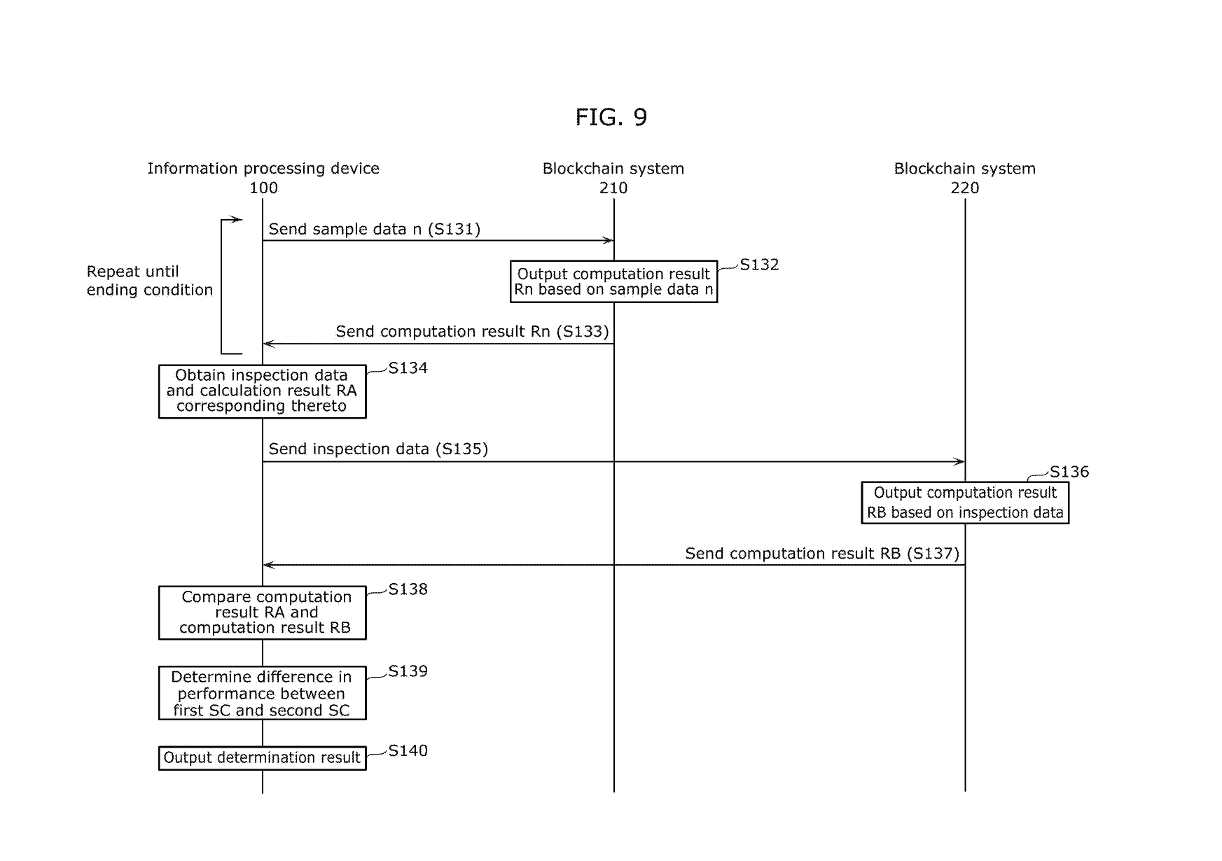

FIG. 9 is a sequence chart illustrating an example of a method for evaluating the performance of a smart contract.

Information processing device 100 sends sample data n to blockchain system 210 (S131).

Blockchain system 210 outputs computation result Rn for sample data n based on sample data n (S132), and sends the output computation result Rn to information processing device 100 (S133). Computation result Rn is the computation result from the first smart contract stored in blockchain system 210 for sample data n.

Information processing device 100 obtains a predetermined number of items of inspection data and computation result RA corresponding thereto by repeating step S131 until an ending condition (S134). In other words, information processing device 100 obtains, as computation result RA, N fifth computation results from the first smart contract, corresponding to N items of the inspection data stored (where N is a natural number of 2 or more). This inspection data is an example of first inspection data.

Note that steps S131 to S133 correspond to steps S112, S114, and S120 in FIG. 6.

Information processing device 100 sends the N items of inspection data to blockchain system 220 (S135).

Blockchain system 220 outputs computation result RB including N computation results for the N items of inspection data based on the N items of inspection data (S136), and sends computation result RB output to information processing device 100 (S137). Each of the N computation results included in computation result RB is the computation result from the second smart contract, stored in blockchain system 220, for the inspection data corresponding to that computation result. As a result, information processing device 100 obtains N sixth computation results from the second smart contract, obtained by inputting each of the N items of inspection data to the second smart contract, the N sixth computation results corresponding to the N items of inspection data.

Information processing device 100 compares computation result RA and computation result RB (S138), and based on the comparison result, determines a performance difference between the first smart contract (first SC) and the second smart contract (second SC) (S139). In other words, information processing device 100 determines whether the performance of the second smart contract is equivalent to the performance of the first smart contract based on the comparison result.

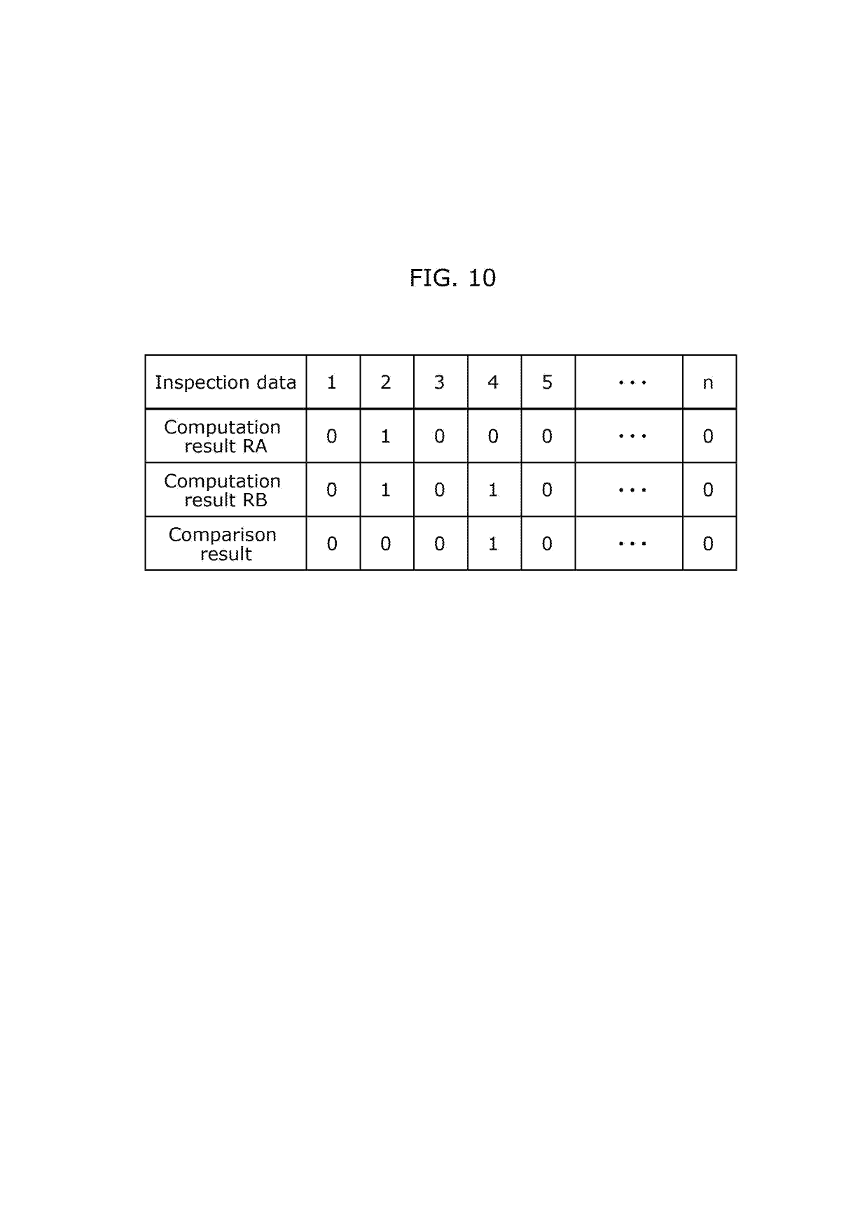

A method for comparing computation result RA and computation result RB will be described here with reference to FIG. 10. FIG. 10 is a diagram illustrating an example of a result of comparing the two computation results from the two smart contracts.

Specifically, information processing device 100 inputs each of the predetermined number of items of inspection data into the first smart contract to be verified, and obtains computation result RA from the first smart contract for each of the predetermined number of items of inspection data. Computation result RA is an output result obtained as a result of the input to the first smart contract, and is a predetermined number of computation results corresponding one-to-one to each of the predetermined number of items of inspection data.

Similarly, information processing device 100 inputs each of the predetermined number of items of inspection data into the second smart contract to compare the performance, and obtains computation result RB from the second smart contract for each of the predetermined number of items of inspection data. Computation result RB is an output result obtained as a result of the input to the second smart contract, and is a predetermined number of computation results corresponding one-to-one to each of the predetermined number of items of inspection data.

Information processing device 100 then compares computation result RA and computation result RB for each corresponding item of inspection data to determine whether the results are identical. In other words, because the comparison result is obtained for each item of inspection data, a predetermined number of determination results are obtained. For example, computation result RA corresponding to inspection data 1 is indicated by “0”, indicating “normal”, and computation result RB corresponding to inspection data 1 is indicated by “0”, also indicating “normal”. The comparison result for inspection data 1 is therefore indicated by “0”, indicating that the computation results are identical. For example, computation result RA corresponding to inspection data 4 is indicated by “0”, indicating normal, and computation result RB corresponding to inspection data 4 is indicated by “1”, indicating an anomaly. The comparison result for inspection data 4 is therefore indicated by “1”, indicating that the computation results are different.

In this manner, information processing device 100 generates N comparison results by comparing N computation results RA and N computation results RB for each of corresponding ones of the first inspection data. Information processing device 100 then determines whether the performance of the second smart contract is equivalent to the performance of the first smart contract based on the total number of comparison results, among the N comparison results, in which the computation results are identical. For example, information processing device 100 may determine that the performance of the second smart contract is equivalent to the performance of the first smart contract when the total number of comparison results, among the N comparison results, in which the computation results are identical is at least M (where M is a natural number smaller than N), and may determine that the performance of the second smart contract is different from the performance of the first smart contract when the total number of comparison results in which the computation results are identical is less than M. M may be determined as a number that is a predetermined percentage of N. The predetermined percentage may be 90% to 100%, for example.

### Operations in Example 2

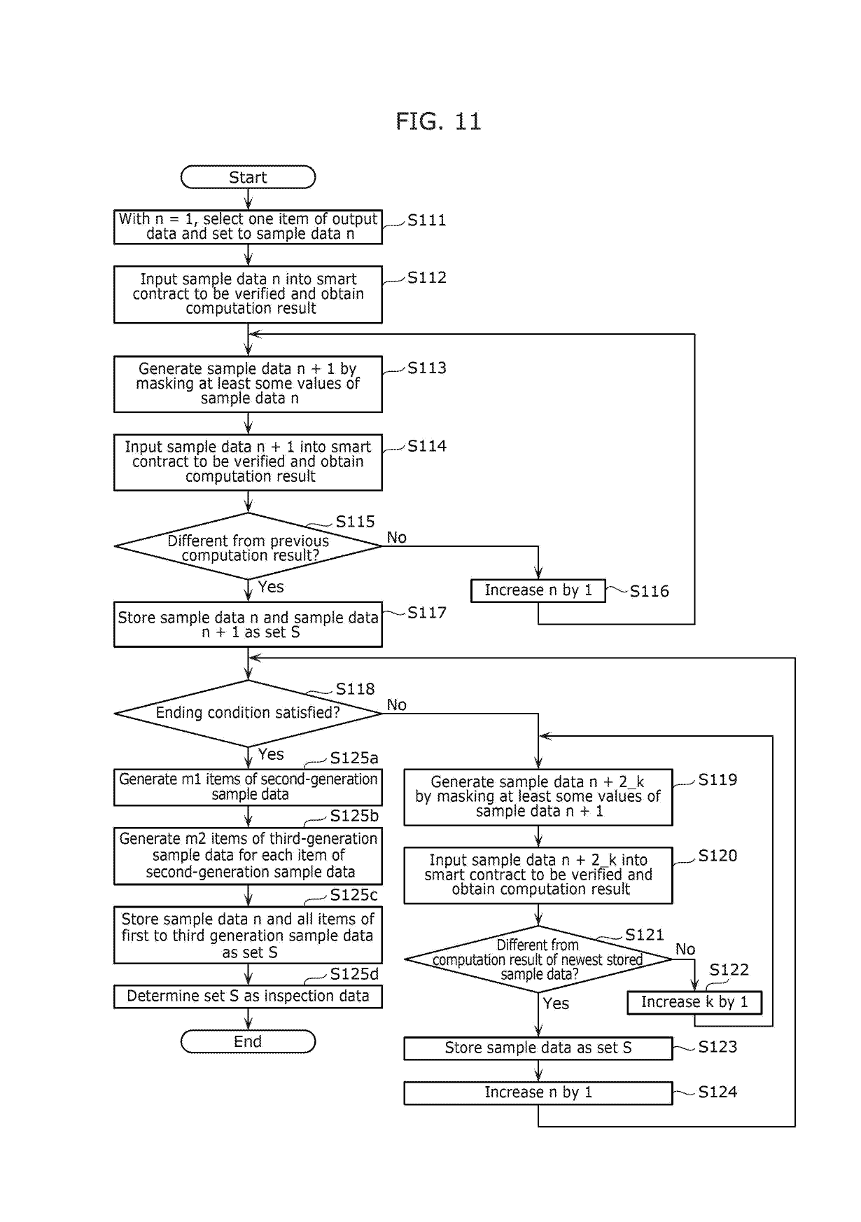

Operations by information processing device 100 according to Example 2 will be described next. FIG. 11 is a flowchart illustrating a control method executed by the information processing device according to Example 2.

Information processing device 100 executes the processing of steps S111 to S124 in the same manner as in Example 1.

Example 2 differs from Example 1 in that if a determination of Yes is made in step S118, information processing device 100 executes steps S125a to S125d instead of step S125.

Information processing device 100 generates m1 items of second-generation sample data n + 1 based on stored sample data n + 1 (first-generation) (S125a). Here, the second-generation sample data n + 1 is sample data generated by repeating, for m1 times, a process of adding a random value smaller than the norm of sample data n + 1 (first-generation) to one item of sample data n + 1 (first-generation), while changing the random value. Note that m1 is a natural number of 2 or more. m1 is an example of L.

Information processing device 100 generates m2 items of third-generation sample data n + 1 based on each of the m1 items of second-generation sample data n + 1 (S125b). Here, third-generation sample data n + 1 is sample data generated by repeating, for m2 times, a process of adding a random value smaller than the norm of second-generation sample data n + 1 to each items of second-generation sample data n + 1, while changing the random value. Note that m2 is a natural number of 2 or more.

Note that step S125b need not be executed, and next-generation sample data n + 1 may be generated. In other words, after step S125b, information processing device 100 may generate mn (J + 1)-th generation sample data n + 1 by repeating, for mn times, a process of adding a random value smaller than the norm of J-th generation sample data n + 1 for each of J-th generation sample data n + 1 (where J is a natural number of 1 or more), while changing the random value.

Information processing device 100 stores sample data n and all items of first- to third-generation sample data as set S (S125c).

Information processing device 100 determines each of the plurality of items of sample data stored as set S as the inspection data (S125d).

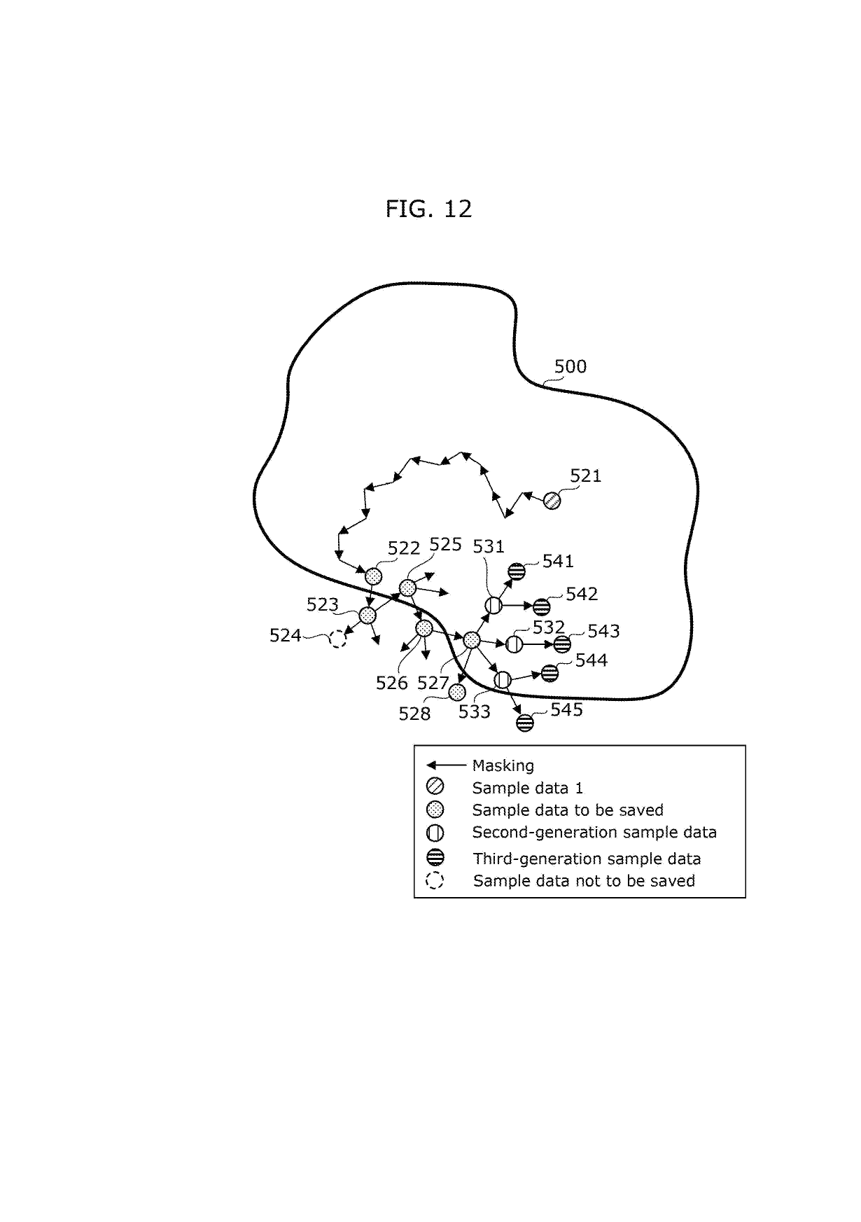

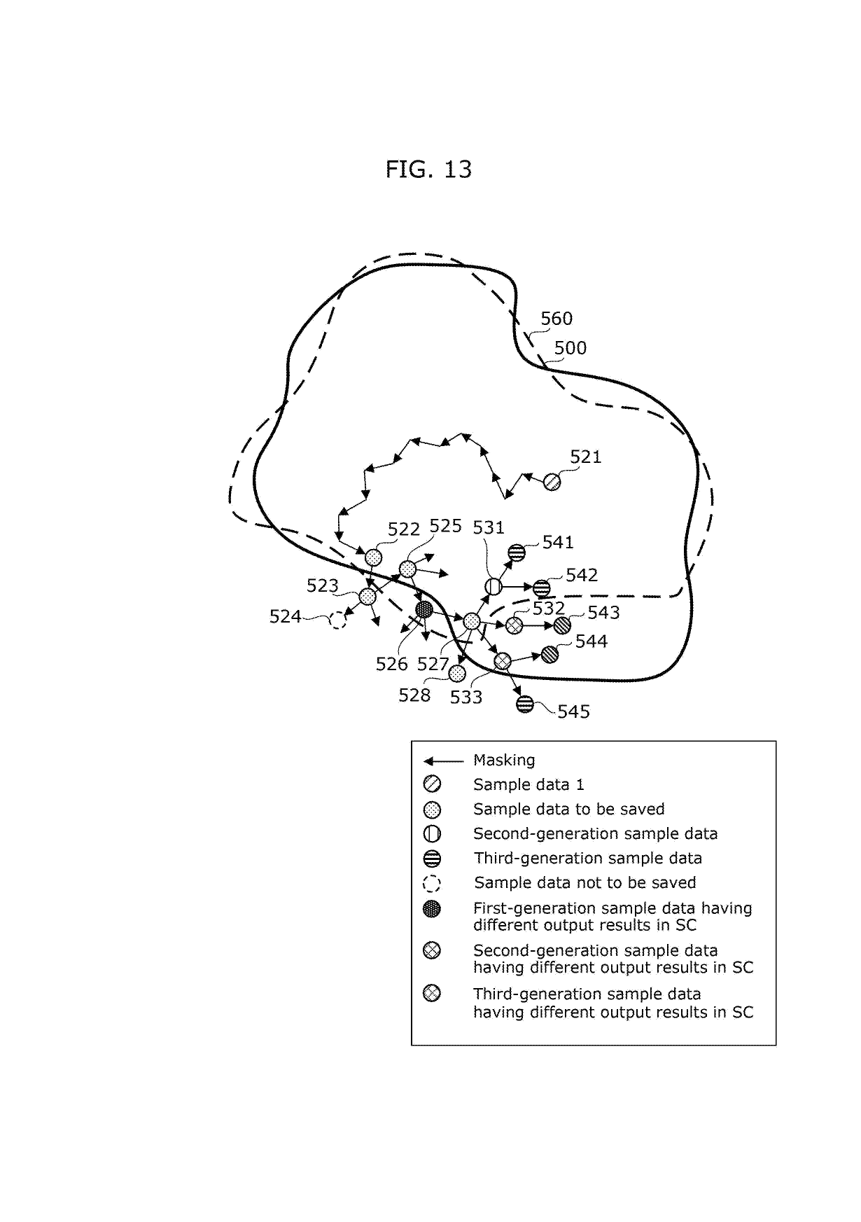

FIG. 12 is a schematic diagram illustrating a relationship between inspection data and a computation result for a smart contract according to Example 2. FIG. 13 is a schematic diagram illustrating a relationship between inspection data and a computation result for two smart contracts according to Example 2.

For example, as illustrated in FIG. 12, information processing device 100 identifies sample data to be stored as inspection data by repeating steps S111 to S124.

For example, information processing device 100 generates three items of second-generation sample data 531 to 533 by repeating, for three times, a process of adding a random value smaller than a norm of sample data 527 to sample data 527, while changing the random value. For example, information processing device 100 generates third-generation sample data 541 to 545 and so on by repeating, for three times, a process of adding a random value smaller than the norm of second-generation sample data 531 to 533 to each of second-generation sample data 531 to 533, while changing the random value. In this manner, information processing device 100 generates second- and third-generation sample data by masking the first-generation sample data, and stores the first- to third-generation sample data as inspection data. The second-generation sample data is data generated regardless of whether the computation result is different, and is therefore more likely to be located far from the boundary of the smart contract than the first-generation sample data. Likewise, the third-generation sample data is more likely to be located far from the boundary of the smart contract than the second-generation sample data. In this manner, as the generation increases, so too does the likelihood that the sample data will be located far from the boundary of the smart contract.

In FIG. 13, a boundary of determination by the second smart contract different from the first smart contract is expressed as an annular line 560, in addition to the content of FIG. 12. As indicated by line 560, the second smart contract is a smart contract having a greater difference from line 500 of the first smart contract than the second smart contract indicated by line 550.

In FIG. 13, the computation results for second-generation sample data 532 and 533 and third-generation sample data 543 and 544 are now different from those in FIG. 8. In this manner, in Example 2, the second-generation sample data and the third-generation sample data, which are likely to be located farther from line 500 indicating the boundary of the determination by the first smart contract than the first-generation sample data, are also determined as inspection data, which makes it easier to identify the sample data of different computation results even when the difference between the first smart contract and the second smart contract is great.

### Effects, Etc.

Information processing device 100 (a device) according to the present embodiment executes the following control method. Information processing device 100 obtains a first computation result from a first smart contract stored on a first blockchain by inputting first data to the first smart contract. Information processing device 100 generates second data by adding a random value smaller than a norm of the first data to the first data. Information processing device 100 obtains a second computation result from the first smart contract by inputting the second data to the first smart contract. Information processing device 100 stores the first data and the second data as first inspection data, based on a comparison result of comparing the first computation result and the second computation result.

Through this, two items of first data and second data different from each other by less than the norm of the first data, e.g., first data and second data for which the computation results from the first smart contract are different, can be identified. In other words, two items of data near a boundary separating the computation results from the first smart contract can be identified, and those two items of data can be stored as inspection data. Accordingly, data effective for accurately comparing the performance of the first smart contract with another smart contract can be identified and stored as the inspection data.

In addition, information processing device 100 stores the first data and the second data as the first inspection data when the first computation result and the second computation result are different. Information processing device 100 skips the storing of the first data and the second data when the first computation result and the second computation result are identical.

Through this, two items of first data and second data different from each other by less than the norm of the first data, and for which the computation results from the first smart contract are different, can be identified. In other words, two items of data near a boundary separating the computation results from the first smart contract can be identified, and those two items of data can be stored as inspection data. Accordingly, data effective for accurately comparing the performance of the first smart contract with another smart contract can be identified and stored as the inspection data.

Information processing device 100 further performs the following processing. Information processing device 100 generates third data by adding a random value smaller than a norm of the second data to the second data. Information processing device 100 obtains a third computation result from the first smart contract by inputting the third data to the first smart contract. Information processing device 100 stores the second data and the third data as the first inspection data based on a comparison result of comparing the second computation result and the third computation result.

Accordingly, based on the second data already stored as inspection data, third data which is different from the second data by less than the norm of the second data, and for which the computation result from the first smart contract is different from that for the second data, can be identified. Accordingly, data effective for accurately comparing the performance of the first smart contract with another smart contract can be further identified and stored as the inspection data.

Information processing device 100 further performs the following processing. Information processing device 100 skips the storing of the second data and the third data when the second computation result and the third computation result are identical. Information processing device 100 generates fourth data different from the third data by adding a random value smaller than the norm of the second data to the second data. Information processing device 100 obtains a fourth computation result from the first smart contract by inputting the fourth data to the first smart contract. Information processing device 100 stores the second data and the fourth data as the first inspection data when the second computation result and the fourth computation result are different.

Accordingly, based on the second data already stored as inspection data without storing the third data for which the computation result is identical to that of the second data, data which is different from the second data by less than the norm of the second data, and for which the computation result from the first smart contract is different from that for the second data, is identified. In other words, because data satisfying the stated condition is searched for with respect to the second data, one item of data can be identified with ease. Accordingly, data effective for accurately comparing the performance of the first smart contract with another smart contract can be further identified and stored as the inspection data.

Information processing device 100 further performs the following processing. Information processing device 100 obtains, from the first smart contract, N fifth computation results corresponding to N items of the first inspection data stored, N being a natural number of 2 or more. Information processing device 100 obtains N sixth computation results from a second smart contract by inputting each of the N items of the first inspection data to the second smart contract, the N sixth computation results corresponding to the N items of the first inspection data. Information processing device 100 determines whether a performance of the second smart contract is equivalent to a performance of the first smart contract based on a comparison result of comparing corresponding ones of the N fifth computation results and the N sixth computation results. Information processing device 100 outputs a determination result of the determining.

Because N items of the first inspection data are used to determine whether the performance of the first smart contract and the performance of the second smart contract are equivalent, a determination result with good accuracy can be obtained.

Information processing device 100 generates N comparison results by comparing the N fifth computation results and the N sixth computation results for each of corresponding ones of the first inspection data. Information processing device 100 determines whether the performance of the second smart contract is equivalent to the performance of the first smart contract based on a total number of the N comparison results in which corresponding ones of the fifth computation results and the sixth computation results are identical.

Accordingly, it is easy to determine whether the performance of the first smart contract and the performance of the second smart contract are equivalent.

When the total number of the N comparison results in which corresponding ones of the fifth computation results and the sixth computation results are identical is at least M, information processing device 100 determines the performance of the second smart contract to be equivalent to the performance of the first smart contract, and when the total number is less than M, information processing device 100 determines the performance of the second smart contract to be different from the performance of the first smart contract, M being a natural number smaller than N. M is a number that is a predetermined percentage of N.

Accordingly, it is easy to determine whether the performance of the first smart contract and the performance of the second smart contract are equivalent.

Information processing device 100 further performs the following processing. Information processing device 100 generates L items of second inspection data by repeating, L times, a process of adding, to one item of the first inspection data among N items of the first inspection data stored, a random value smaller than a norm of the first inspection data, the L items of the second inspection data being different from the N items of the first inspection data, N being a natural number of 2 or more, and L being a natural number of 2 or more. Information processing device 100 obtains, from the first smart contract, (N + L) seventh computation results corresponding to the N items of the first inspection data and the L items of the second inspection data. Information processing device 100 obtains (N + L) eighth computation results from a second smart contract by inputting the N items of the first inspection data and the L items of the second inspection data to the second smart contract, the (N + L) eighth computation results corresponding to respective ones of the N items of the first inspection data and the L items of the second inspection data. Information processing device 100 determines whether a performance of the second smart contract is equivalent to a performance of the first smart contract based on a comparison result of comparing the (N + L) seventh computation results and the (N + L) eighth computation results. Information processing device 100 outputs a determination result of the determining.

Through this, the performance of the first smart contract and the performance of the second smart contract are determined to be equivalent using the first inspection data and the second inspection data having a lower determination result accuracy than the first inspection data, and it is therefore possible to determine whether the performance of the first smart contract and the performance of the second smart contract are equivalent with greater accuracy.

Information processing device 100 also performs the following processing. Information processing device 100 generates (N + L) comparison results by comparing the (N + L) seventh computation results and the (N + L) eighth computation results for each of corresponding ones of the first inspection data or each of corresponding ones of the second inspection data. Information processing device 100 performs the determining such that of the (N + L) comparison results, N comparison results for corresponding ones of the first inspection data have a greater effect than L comparison results for corresponding ones of the second inspection data.

Through this, it is determined whether the performance of the first smart contract and the performance of the second smart contract are equivalent such that the comparison result for the first inspection data has a greater effect than the comparison result for the second inspection data, and it is therefore possible to determine whether the performance of the first smart contract and the performance of the second smart contract are equivalent with greater accuracy.

### Variation

In the foregoing embodiment, during the masking, the random value added to the sample data to be masked is assumed to be lower than the norm of the sample data, but the random value is not limited thereto, and may be lower than the norm of any one of the plurality of items of sample data.

### Supplemental Descriptions

Supplemental descriptions of the distributed ledger used in the foregoing embodiment or variations will be given next. Although a blockchain is described here as an example of a distributed ledger, the same applies to other distributed ledgers as well.

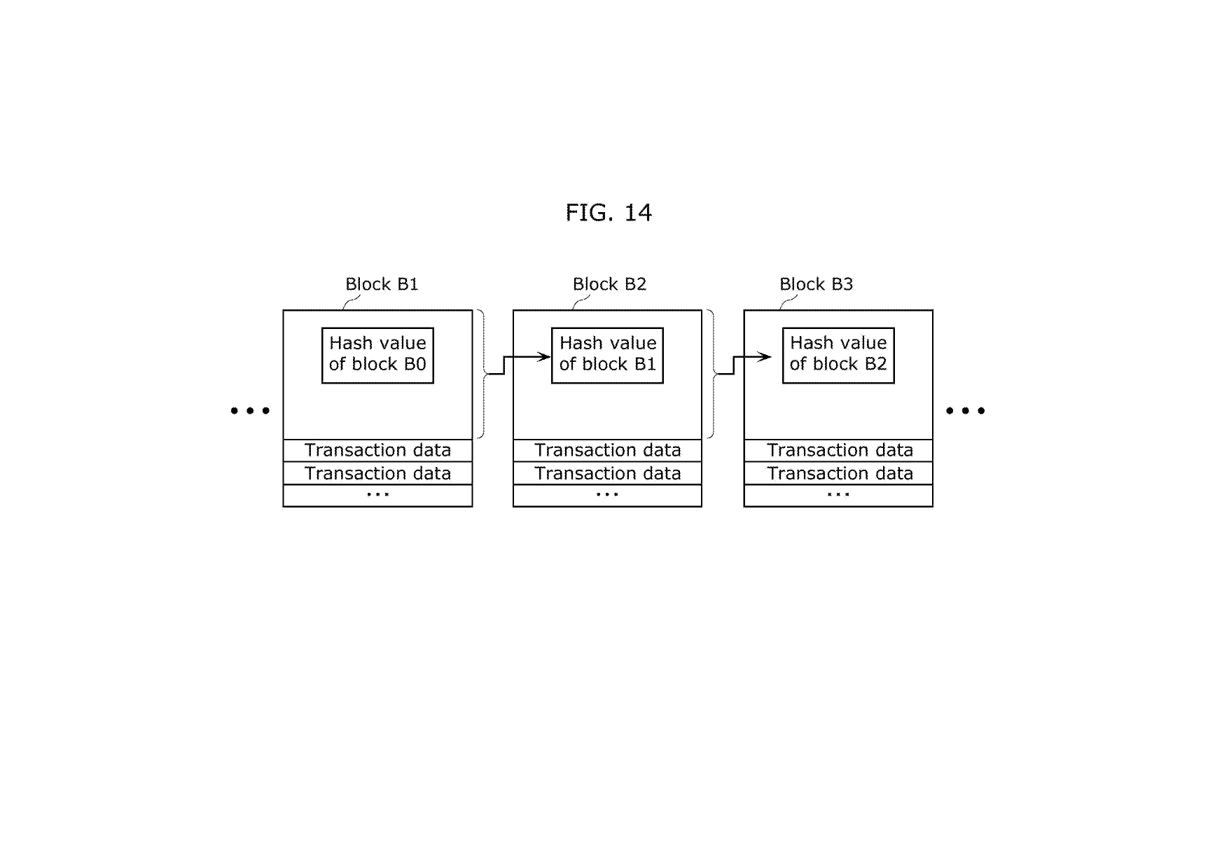

FIG. 14 is an explanatory diagram illustrating the data structure of a blockchain.

A “blockchain” is a connection of blocks, which serve as a unit of record, in the form of a chain. Each block includes a plurality of items of transaction data and a hash value of the block immediately previous in the chain. Specifically, block B2 includes the hash value of block B1, which is immediately previous in the chain. A hash value computed from the plurality of items of transaction data included in block B2 and the hash value of block B1 is then included in block B3 as the hash value of block B2. Connecting the blocks in a chain with each block including the details of the previous block as a hash value in this manner makes it possible to effectively prevent tampering with the recorded transaction data.

If, for example, a past item of transaction data has been changed, the hash value of the block will have a value different from the pre-change value. This means that to make a block which has been tampered with appear normal, it is necessary to rebuild all the blocks previous thereto, which is a task that is extremely difficult in practice. This characteristic is used to ensure that it is difficult to tamper with the blockchain.

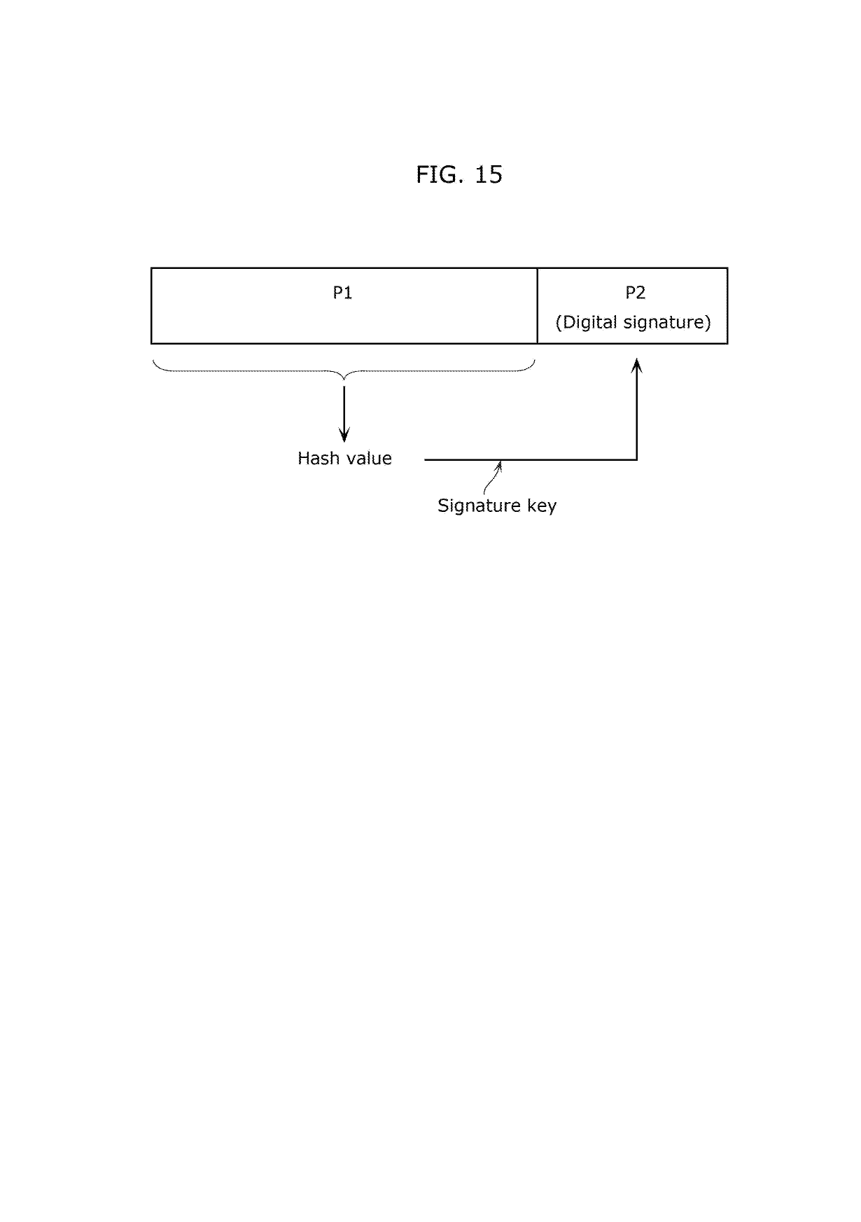

FIG. 15 is an explanatory diagram illustrating the data structure of transaction data.

The transaction data illustrated in FIG. 15 contains main transaction part P1 and digital signature P2. Main transaction part P1 is the main data of that transaction data. Digital signature P2 is a digital signature generated using a signature key of the creator of the transaction data on the hash value of main transaction part P1, and more specifically, is generated by encrypting the hash value using a private key of the creator of the transaction data. The digital signature method is, for example, the Elliptic Curve Digital Signature Algorithm (ECDSA), CRYSTALS-Dilithium, Falcon, SPHINCS+, or the like.

The transaction data has digital signature P2 and is therefore substantially impossible to be tampered with. This is because if the transaction data is tampered with, verification using digital signature P2 will fail, making it clear that the transaction data has been tampered with. This prevents main transaction part P1 itself from being tampered with.

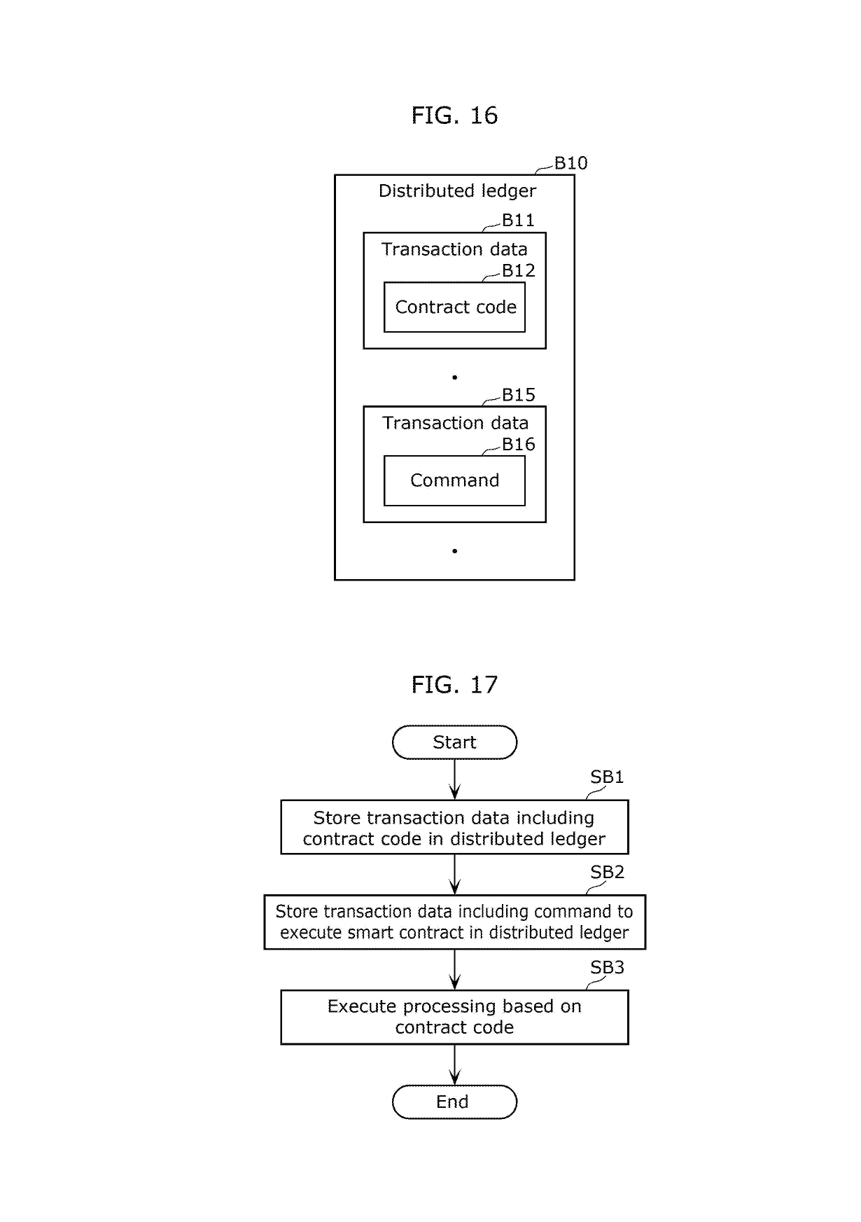

FIG. 16 is an explanatory diagram illustrating transaction data related to the execution of a smart contract. FIG. 17 is an explanatory diagram illustrating processing related to the execution of a smart contract.

A series of processing for executing a smart contract using a distributed ledger will be described with reference to FIGS. 16 and 17.

In step SB1, a node stores transaction data B11, including contract code B12 describing the processing of the smart contract, in distributed ledger B10. For example, the node obtains transaction data B11 by receiving transaction data B11 through communication from an information processing device, or by the node itself generating transaction data B11, and stores transaction data B11 obtained in distributed ledger B10. Step SB1 is performed before executing the smart contract.

In step SB2, the node stores transaction data B15, including command B16 to execute the smart contract, in distributed ledger B10. For example, the node receives transaction data B15 through communication from an information processing device, and stores transaction data B15 received in distributed ledger B10.

In step SB3, the node reads out contract code B12 from distributed ledger B10 in response to transaction data B15, including command B16, being stored in distributed ledger B10 in step SB2, and executes processing based on contract code B12. The result of the processing may be included in the transaction data and stored in distributed ledger B10.

Through the foregoing series of processing, when transaction data B15 including command B16 to execute the smart contract is received, the distributed ledger system automatically (i.e., without requiring work to be performed by a person) executes processing in accordance with command B16, and thus the processing can be executed with a high level of efficiency (i.e., quickly, or in a short period of time). Implementing highly-efficient processing has the effect of reducing power consumption. In addition, because work by a person is not required, situations where a person tampers with the information, acts improperly, or makes a human error can be avoided. Furthermore, the result of the processing executed in this manner is stored in the blockchain, which can make it substantially impossible for the result of the processing to be tampered with.

In the foregoing embodiment and variations, the constituent elements are constituted by dedicated hardware. However, the constituent elements may be realized by executing software programs corresponding to those constituent elements. Each constituent element may be realized by a program executing unit such as a CPU or a processor reading out and executing a software program recorded into a recording medium such as a hard disk or semiconductor memory. Here, the software that realizes the information processing device (i.e., a virtual space management server) and the like according to the foregoing embodiment and variations is a program such as that described below.

In other words, the program is a program for causing a computer to execute a control method performed by a device. The control method includes: obtaining a first computation result from a first smart contract stored on a first blockchain by inputting first data to the first smart contract; generating second data by adding a random value smaller than a norm of the first data to the first data; obtaining a second computation result from the first smart contract by inputting the second data to the first smart contract; and storing the first data and the second data as first inspection data, based on a comparison result of comparing the first computation result and the second computation result.

A device (information processing device 100) and the like according to one or more aspects have been described based on an embodiment, but the present disclosure is not limited to this embodiment. Variations on the embodiment conceived by one skilled in the art, embodiments implemented by combining constituent elements from different other embodiments, and the like may be included in the scope of one or more aspects as well, as long as they do not depart from the essential spirit of the present disclosure.

### INDUSTRIAL APPLICABILITY

The present disclosure is useful as a control method and the like enabling the identification and storage of data effective for accurately and efficiently comparing the performance of a smart contract with another smart contract.

1. A control method performed by a device, the control method comprising:
obtaining a first computation result from a first smart contract stored on a first blockchain by inputting first data to the first smart contract;
generating second data by adding a random value smaller than a norm of the first data to the first data;
obtaining a second computation result from the first smart contract by inputting the second data to the first smart contract; and
storing the first data and the second data as first inspection data, based on a comparison result of comparing the first computation result and the second computation result.

2. The control method according to claim 1,
wherein the first data and the second data are stored as the first inspection data when the first computation result and the second computation result are different, and
the storing of the first data and the second data is skipped when the first computation result and the second computation result are identical.

3. The control method according to claim 1, further comprising:
generating third data by adding a random value smaller than a norm of the second data to the second data;
obtaining a third computation result from the first smart contract by inputting the third data to the first smart contract; and
storing the second data and the third data as the first inspection data based on a comparison result of comparing the second computation result and the third computation result.

4. The control method according to claim 3, further comprising:
skipping the storing of the second data and the third data when the second computation result and the third computation result are identical;
generating fourth data different from the third data by adding a random value smaller than the norm of the second data to the second data;
obtaining a fourth computation result from the first smart contract by inputting the fourth data to the first smart contract; and
storing the second data and the fourth data as the first inspection data when the second computation result and the fourth computation result are different.

5. The control method according to claim 1, further comprising:
obtaining, from the first smart contract, N fifth computation results corresponding to N items of the first inspection data stored, N being a natural number of 2 or more;
obtaining N sixth computation results from a second smart contract by inputting each of the N items of the first inspection data to the second smart contract, the N sixth computation results corresponding to the N items of the first inspection data;
determining whether a performance of the second smart contract is equivalent to a performance of the first smart contract based on a comparison result of comparing corresponding ones of the N fifth computation results and the N sixth computation results; and
outputting a determination result of the determining.

6. The control method according to claim 5,
wherein N comparison results are generated by comparing the N fifth computation results and the N sixth computation results for each of corresponding ones of the first inspection data, and
whether the performance of the second smart contract is equivalent to the performance of the first smart contract is determined based on a total number of the N comparison results in which corresponding ones of the fifth computation results and the sixth computation results are identical.

7. The control method according to claim 6,
wherein when the total number of the N comparison results in which corresponding ones of the fifth computation results and the sixth computation results are identical is at least M, the performance of the second smart contract is determined to be equivalent to the performance of the first smart contract, and when the total number is less than M, the performance of the second smart contract is determined to be different from the performance of the first smart contract, M being a natural number smaller than N, and
M is a number that is a predetermined percentage of N.

8. The control method according to claim 1, further comprising:
generating L items of second inspection data by repeating, L times, a process of adding, to one item of the first inspection data among N items of the first inspection data stored, a random value smaller than a norm of the first inspection data, the L items of the second inspection data being different from the N items of the first inspection data, N being a natural number of 2 or more, and L being a natural number of 2 or more;
obtaining, from the first smart contract, (N + L) seventh computation results corresponding to the N items of the first inspection data and the L items of the second inspection data;
obtaining (N + L) eighth computation results from a second smart contract by inputting the N items of the first inspection data and the L items of the second inspection data to the second smart contract, the (N + L) eighth computation results corresponding to respective ones of the N items of the first inspection data and the L items of the second inspection data;
determining whether a performance of the second smart contract is equivalent to a performance of the first smart contract based on a comparison result of comparing the (N + L) seventh computation results and the (N + L) eighth computation results; and
outputting a determination result of the determining.

9. The control method according to claim 8,
wherein (N + L) comparison results are generated by comparing the (N + L) seventh computation results and the (N + L) eighth computation results for each of corresponding ones of the first inspection data or each of corresponding ones of the second inspection data, and
the determining is performed such that of the (N + L) comparison results, N comparison results for corresponding ones of the first inspection data have a greater effect than L comparison results for corresponding ones of the second inspection data.

10. A device comprising:
a processor; and
memory connected to the processor,
wherein using the memory, the processor:
obtains a first computation result from a first smart contract stored on a first blockchain by inputting first data to the first smart contract;
generates second data by adding a random value smaller than a norm of the first data to the first data;
obtains a second computation result from the first smart contract by inputting the second data to the first smart contract; and
stores the first data and the second data as first inspection data, based on a comparison result of comparing the first computation result and the second computation result.

11. A non-transitory computer-readable recording medium having recorded thereon a program for causing a computer to execute a control method performed by a device, the control method comprising:
obtaining a first computation result from a first smart contract stored on a first blockchain by inputting first data to the first smart contract;
generating second data by adding a random value smaller than a norm of the first data to the first data;
obtaining a second computation result from the first smart contract by inputting the second data to the first smart contract; and
storing the first data and the second data as first inspection data, based on a comparison result of comparing the first computation result and the second computation result.
